(19) United States
(12) Patent Application Publication
(10) Pub. No.: US 2021/0051979 A1
(43) Pub. Date: Feb. 25, 2021

(54) HYDROLYZED COLLAGEN FOR ANIMAL CHEW PRODUCTS

(71) Applicant: MPet Group Corp., Aventura, FL (US)

(72) Inventors: Isaac Mendal, Aventura, FL (US); Segundo Eliecer Cuadrado, Bogota (CO)

(21) Appl. No.: 16/993,130

(22) Filed: Aug. 13, 2020

Related U.S. Application Data
(60) Provisional application No. 62/888,924, filed on Aug. 19, 2019.
(60) Provisional application No. 62/958,655, filed on Jan. 8, 2020.

(51) Int. Cl. A23K 10/20; A01K 15/02; A23K 40/00; A23K 50/42

(52) U.S. Cl. CPC A23K 10/20; A23K 50/42; A23K 40/00; A01K 15/026

(57) ABSTRACT

Techniques for a process for hydrolyzed collagen for animal chew products are disclosed. In some embodiments, a process for hydrolyzed collagen for animal chew products includes pretreating raw animal hide material; adding acid sufficient to adjust a pH level of the pretreated raw animal hide material to a pH level between 8 and 9 in a tank; adding enzymes for partially hydrolyzing collagen in the raw animal hide material, wherein a temperature range between 50 and 60 degrees is maintained for a period of time of approximately 30 to 45 minutes; draining the tank and adding acid until the pH level is below 4 to stop a hydrolysis of the raw animal hide material to provide a treated raw material; and drying and grinding the treated raw material.

### CROSS REFERENCE TO OTHER APPLICATIONS

This application claims priority to U.S. Provisional Patent Application No. 62/888,924 entitled HYDROLYZED COLLAGEN FOR ANIMAL CHEW PRODUCTS filed Aug. 19, 2019 and U.S. Provisional Patent Application No. 62/958,655 entitled HYDROLYZED COLLAGEN FOR ANIMAL CHEW PRODUCTS filed Jan. 8, 2020, both of which are incorporated herein by reference for all purposes.

### BACKGROUND OF THE INVENTION

Pet animal chew products, such as rawhides, are generally made from animal byproducts, such as animal bones and/or animal skins. For example, the animal byproducts can come from a hide split (i.e., a lower layer or inner layer of the skin's flesh side that can be split away from the upper/grain layer, which is commonly used for various other commercial products, such as leather products).

The animal byproducts are typically further processed and then dried. The resulting materials can then be cut to size and can further be rolled or otherwise shaped into a pet animal chew product.

### BRIEF DESCRIPTION OF THE DRAWINGS

Various embodiments of the invention are disclosed in the following detailed description and the accompanying drawings.

FIG. 1 is a flow diagram illustrating a process for hydrolyzed collagen for animal chew products in accordance with some embodiments.

FIGS. 2A-2D are diagrams illustrating examples of a shaped collagen chews resulting from performing the process for hydrolyzed collagen for animal chew products in accordance with some embodiments.

### DETAILED DESCRIPTION

The invention can be implemented in numerous ways, including as a process and/or a composition of matter. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Pet animal chew products, such as rawhides, are generally made from animal byproducts, such as animal bones and/or animal skins. For example, the animal byproducts can come from a hide split (i.e., a lower layer or inner layer of the skin's flesh side that can be split away from the upper/grain layer, which is commonly used for various other commercial products, such as leather products).

The animal byproducts are typically further processed and then dried. The resulting materials can then be cut to size and can further be rolled or otherwise shaped into a pet animal chew product.

Collagen is a well-known protein. Collagen generally is an insoluble fibrous protein (e.g., fibril-type collagens are a common protein in connective tissue in animals). While collagen has been added into pet animal chew products (e.g., some rawhide products naturally contain collagen), the existing approaches have several shortcomings that fail to provide a resulting pet animal chew product (e.g., a chew for a domestic animal) that is both long lasting and easily digestible by pet animals (e.g., chew products for canines).

Accordingly, new and improved techniques for a process for hydrolyzed collagen for animal chew products are disclosed.

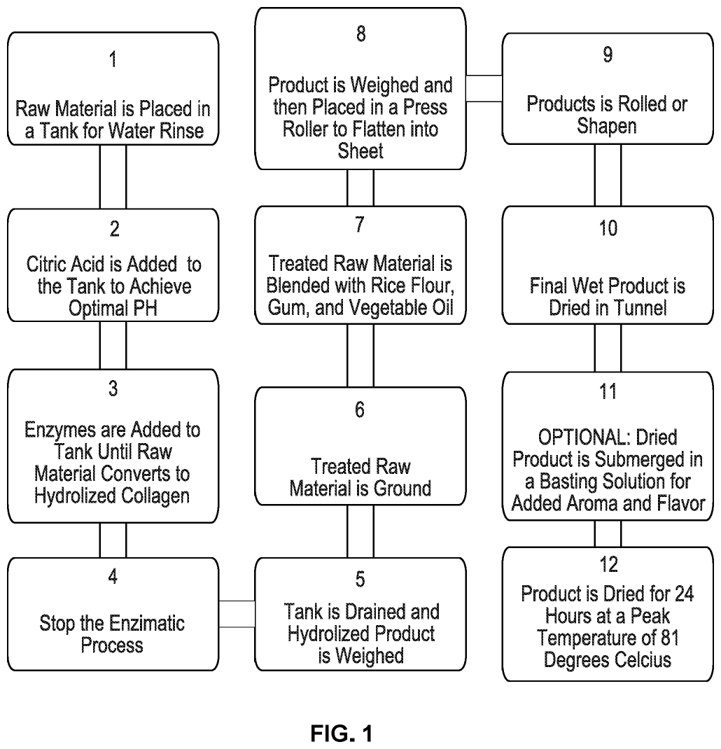

FIG. 1 is a flow diagram illustrating a process for hydrolyzed collagen for animal chew products in accordance with some embodiments. FIG. 1 is illustrated below.

In some embodiments, the process for hydrolyzed collagen for animal chew products includes the following example ingredients: raw materials, such as bovine or swine tissue (e.g., or other animal byproducts can be used for these raw materials); citric acid; enzymes, such as Bromelain and Papain (e.g., or other enzymes can be used, such as, for example, Lyases, Isomerases, Trypsin, Chymotrypsin, Elastase, Lipases, Pepsin, and/or Protease); rice flour; CMC gum; vegetable oil; and other ingredients can be used or optionally included as further described below.

Referring to a first stage as shown at 1 in FIG. 1, the raw material (e.g., bovine and swine animal hide material) is placed into a tank in order to soak it with water.

Referring to a second stage as shown at 2 in FIG. 1, citric acid is added (e.g., 0.5% to 2% of raw material's weight) to adjust the pH level between, for example, 8 and 9.

Referring to a third stage as shown at 3 in FIG. 1, enzymes are introduced in the process with the purpose of partially hydrolyzing the collagen that the raw material contains. In an example implementation, for the enzymes to perform efficiently, we can adjust the temperature to be between 50 and 60 degrees Celsius (i.e., between 122 and 140 degrees Fahrenheit), then add 0.03% to 2% of the enzyme, and then allow the process to perform for approximately 30 to 45 minutes.

Referring to a fourth stage as shown at 4 in FIG. 1, the tank is drained, and the enzymes are then taken out of their optimal pH levels by adding 0.5% to 2% of citric acid until the pH level is below 4. This allows hydrolysis of the raw material to stop at a point in the process that facilitates obtaining the desired hydrolyzed collagen. In this example implementation, a final rinse is performed with fresh water to wash residual acid and to result in a pH level of approximately 7. In this example implementation, the raw materials are hydrolyzed until a mass loss of between 20-50% is achieved.

Referring to a fifth stage as shown at 5 in FIG. 1, the tank is drained once the hydrolyzed collagen is attained as described above. The solids (e.g., treated raw material) can then be removed from the tank and weighed.

Referring to a sixth stage as shown at 6 in FIG. 1, the treated raw material is ground. For example, the treated raw material is ground can be ground into small particles between 2 and 5 mm (i.e., between 0.08″ and 0.2″ inches).

Referring to a seventh stage as shown at 7 in FIG. 1, the treated raw material is placed into a mixer where the following example ingredients are added: dry beef digest, rice flour, gum (e.g., CMC and Xanthan), gelatin, and a preservative (e.g., Potassium Sorbate) until a homogeneous mass is achieved.

Referring to an eight stage as shown at 8 in FIG. 1, result product after the blend is weighted and then placed in a press roller to flatten into a sheet(s) (e.g., or it can be placed in a high-pressure extruder and then press rollers can be used to further flatten into a sheet(s)). For example, the product can be weighed and then placed in the press roller to be passed through spreading pressure rolls flattening the mass into a thinner film between 1 to 3 mm.

Referring to a ninth stage as shown at 9 in FIG. 1, the product (e.g., thin film) is cut into strips, which will be rolled or folded into individual pieces. For example, the product can be rolled or shaped into a desired resulting form/shape for the animal chew product.

Referring to a tenth stage as shown 10 in FIG. 1, the formed/shaped products are placed in ovens (e.g., a tunnel oven) for a period of time, such as 4-5 days at a temperature between 55 to 80 degrees Celsius, to obtain a humidity content between 10% and 15%.

Referring to an eleventh (optional) stage as shown at 11 in FIG. 1, the dried product can be basted to enhance the flavor and palatability for the animal chew product. For example, a basting solution can be applied to the dried product for added aroma and flavor (e.g., the basting solution can be applied by spraying, tumbling, curtain coating, or submerging the applied product). Various other ingredients can also be added for flavor and/or nutrition (e.g., other vitamins or supplements, such as for joint pain or flexibility and/or other purposes).

A slurry can also be applied during this eleventh (optional) stage to provide a more palatable animal chew product. In one embodiment, a slurry includes the following ingredients and recipe.

| Ingredient | Units (grams) | % of Formula |
|---|---|---|
| Water | 1,000 | 72.3% |
| Real Chicken | 200 | 14.5% |
| Tapioca Starch | 50 | 3.6% |
| Glycerin | 50 | 3.6% |
| Gelatin | 50 | 3.6% |
| Animal Fat | 25 | 1.8% |
| Ascorbic Acid | 4 | 0.3% |
| Natural Flavor | 4 | 0.3% |
| Total Grams | 1,383 | |
| Per Formula | | |

Heat 1 liter (1,000 ml) of water to boiling point.

Add 50 grams of vegetable glycerin to water (e.g., water mixture is hereon considered “solution”).

Add 25 grams animal fat to solution.

Add 4 grams ascorbic acid to a separate 100 ml of water and dilute, add to solution and continue stirring.

Add 4 grams of natural flavor to solution and stir.

Slowly add 50 grams of tapioca starch to solution, stir until no lumps remain and is tapioca starch is completely dissolved.

Add 50 grams of gelatin to a separate 200 ml of hot water and stir until dissolved, add to solution and stir until a homogenous solution is obtained (e.g., without lumps).

Grind 200 grams of animal protein (e.g., beef, chicken, pork or pizzle), add to solution, and stir.

Once the animal protein is fully integrated, add 100 ml of water to obtain a more liquid slurry and liquefy the mixture by mincing the solution in a blender.

Apply slurry onto dry products.

Place dry products with slurry onto trays and place them into drying tunnel for up to 48 hours (e.g., varies by product) at 45° C.

Referring to a twelfth (optional) stage as shown at 12 in FIG. 1, after the optional basting stage, the product is dried again in the tunnel for final packaging. For example, after the optional basting stage, the product can be dried again in ovens (e.g., a tunnel oven) for a period of time, such as for 24 hours at a peak temperature of 81 degrees Celsius.

Once dried, the resulting final product is a hydrolyzed collagen-based, long-lasting chew (e.g., a collagen chew, such as for rawhide free dog treats that includes natural collagen using the above described process) with limited ingredients that allows easy digestibility. For example, the resulting final product is high in protein and collagen and is also long lasting while also being “pre-chewed”, 100% digestible, and 100% pre-chewed.

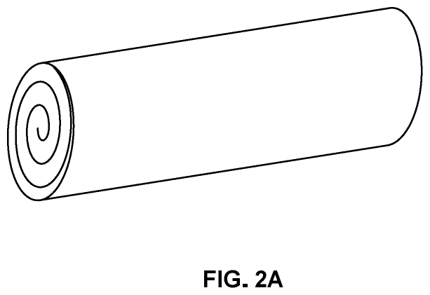

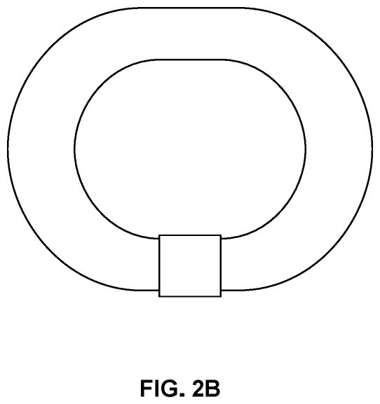

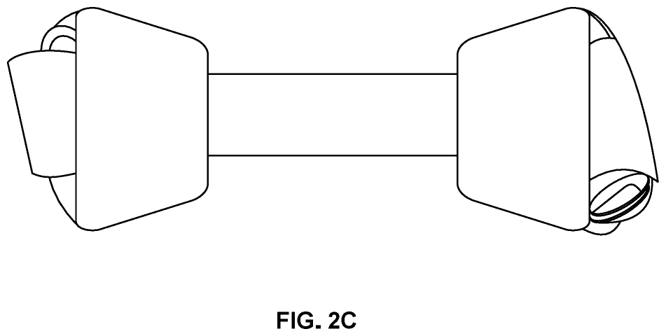

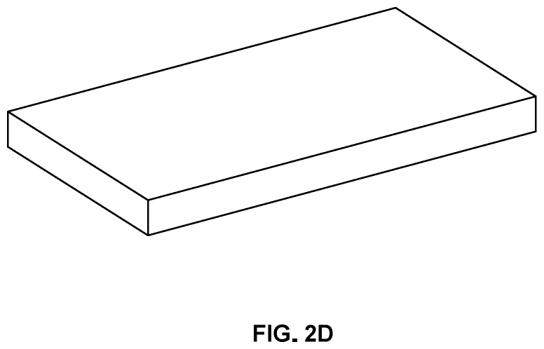

FIGS. 2A-2D are diagrams illustrating examples of a shaped collagen chews resulting from performing the process for hydrolyzed collagen for animal chew products in accordance with some embodiments. FIGS. 2A-2D are illustrated below.

In some embodiments, the above described process can be performed to provide a chew (e.g., a shaped collagen chews, such as for a domestic animal) that comprises partially hydrolyzed collagen derived from raw animal hide material to provide a treated raw material, wherein the treated raw material is ground and formed into a predetermined shape, such as shown in FIGS. 2A-2D.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
pretreating raw animal hide material;
adding acid sufficient to adjust a pH level of the pretreated raw animal hide material to a pH level between 8 and 9 in a tank;
adding enzymes for partially hydrolyzing collagen in the raw animal hide material, wherein a temperature range between 50 and 60 degrees is maintained for a period of time of approximately 30 to 45 minutes;
draining the tank and adding acid until the pH level is below 4 to stop a hydrolysis of the raw animal hide material to provide a treated raw material; and
drying and grinding the treated raw material.

2. The method of claim 1, wherein the treated raw material is cut into an animal chew product.

3. The method of claim 1, wherein the treated raw material is shaped into an animal chew product.

4. The method of claim 1, further comprising:
mixing the treated raw material with one or more other ingredients.

5. The method of claim 1, further comprising:
drying the treated raw material in an oven for a predetermined period of time.

6. The method of claim 1, further comprising:
cutting the treated raw material into strips.

7. The method of claim 1, further comprising:
cutting the treated raw material into strips and forming into a shaped animal chew product.

8. The method of claim 1, further comprising:
apply a basting solution to the treated raw material for added aroma and/or flavor.

9. The method of claim 1, further comprising:
drying the treated raw material in an oven for a predetermined period of time to provide a dried product; and
submerging the dried material in a basting solution for added aroma and/or flavor, wherein the dried product is basted to enhance the flavor and palatability for an animal chew product.

10. The method of claim 1, further comprising:
submerging the treated raw material in a basting solution for added aroma and/or flavor; and
drying the treated raw material in an oven for a predetermined period of time.

11. A chew, comprising:
partially hydrolyzed collagen derived from raw animal hide material to provide a treated raw material, wherein the treated raw material is ground and formed into a predetermined shape.

12. The chew of claim 11, wherein the chew is for a domestic animal.

13. The chew of claim 11, wherein the chew is formed into a roll of sheets configuration.

14. The chew of claim 11, wherein the chew is formed into a circular configuration.

15. The chew of claim 11, wherein the chew is formed into a bone configuration.

16. The chew of claim 11, wherein the chew is formed into a rectangular or square configuration.

17. The chew of claim 11, wherein the chew is submerged in a basting solution for added aroma and/or flavor.

18. The chew of claim 11, further comprising:
dry beef digest, rice flour, gum, gelatin, and/or a preservative.

19. The chew of claim 11, further comprising:
dry beef digest, rice flour, gum, gelatin, and/or a preservative, wherein a resulting product is rolled into sheets of film between 1 to 3 mm in thickness.

20. The chew of claim 11, further comprising:
dry beef digest, rice flour, gum, gelatin, and/or a preservative, wherein a resulting product is rolled into sheets of film between 1 to 3 mm in thickness and formed into at least one of the following shapes: a roll of sheets configuration, a circular configuration, a bone configuration, a rectangular configuration, or a square configuration.
